(19) United States
(12) Patent Application Publication
(10) Pub. No.: US 2004/0047374 A1
(43) Pub. Date: Mar. 11, 2004

(54) Device for multiplexing of data and method for multiplexing of data in system for dataflow management using multiplexers

(75) Inventors: Marcin Wielgosz, Kalisz (PL); Kamil Burzynski, Koluszki (PL); Marek Gruszczynski, Zielona Gora (PL); Miroslaw Kusiak, Zielona Gora (PL); Andrzej Nadachowski, Ostrow Wielkopolski (PL); Janusz Ogrodowczyk, Nowa Sol (PL); Jacek Szpakowski, Zielona Gora (PL)

Correspondence Address: MERCHANT & GOULD PC, P.O. BOX 2903, MINNEAPOLIS, MN, 55402-0903, US

(73) Assignees: Advanced Digital Broadcast Ltd., Hsin-Tien City (TW); Advanced Digital Broadcast Polska Sp. z o.o., Zielona Gora (PL)

(21) Appl. No.: 10/647,883

(22) Filed: Aug. 25, 2003

(30) Foreign Application Priority Data
Aug. 26, 2002 (PL) P-355707

(51) Int. Cl. H04L 12/56; H04J 3/02

(52) U.S. Cl. 370/537; 370/395.4

(57) ABSTRACT

Dataflow inside the system is based on requests for packets send from an E superior system element (120). A packet appearing at one of the inputs of the first or second multiplexers (105, 109) is sent to its output. In case there is no packet at a given input, information about the lack of a packet is sent instead. The reading of the packet from one of the inputs and sending it to the output is activated by a packet request command, sent to modules (110, 111, 112, 113, 114, 115, 116, 117) connected to the given input. The requested packet, or information of its lack, is then awaited. Subsequently, a search for packets is conducted at the TV1, TV3 live signal inputs (101, 106), beginning with the input defined as the first in line. If no packet is found at the highest priority input, the search moves on to subsequent live signal inputs. If no packets are available at these inputs, the TV2 bitrate input (102) is checked, bypassing inputs with a coefficient of sending greater or equal to one. The coefficient of sending is calculated for each of these inputs. It defines the relationship of the amount of data received from a given input to that input's data transmission speed, multiplied by the time elapsed since the amount of data received was last reset. This coefficient is reset following a preset period of time. In case when no packets are found at the bitrate inputs, the search proceeds to check the weight inputs, for example the (103, 104, 108) data inputs.

### BACKGROUND OF THE INVENTION

1. Field of the Invention

The present invention relates to a device for multiplexing of data and a method for multiplexing of data in a system for dataflow management using multiplexers.

2. Brief Description of the Background of the Invention including Prior Art

The published international patent application No. WO 0245459, entitled “A method for multiplexing different bit rate sources” shows a method for multiplexing of multiple inputs, each with a different bitrate. It employs a special arrangement for calculating peak capacity values, guaranteeing good outgoing link performance. The method is two-phase. The first precalculates the capacity of the outgoing link with different numbers of incoming links having equal packet size, forming the results into a table. The second calculates the peak capacity needed for the outgoing link using the precalulated tables.

The European patent application No. EP0973290, entitled “Statistical data multiplexing” presents a method for multiplexing of multiple inputs at which appear data to be transmitted at some given time. In this method, an error value is calculated for each data packet to represent the error between the expected delivery time to the head of the queue and the urgency of the data channel is derived as an average (possibly weighted average) of the error values.

The existing multiplexers in common use allow for multiplexing of specific types of signals, defined by their bitrate or by their specific weight, specifying the amount of data from a single input that will show up at an output, as compared to data from other inputs.

The development in signal transmission techniques, especially in the transmission of digital television signals, created a need for more complicated signal processing devices. In the case of digital television, television programs are broadcast alongside applications and the data to those applications. Television programs have various quality. The higher the quality, and the more information included in the program, the greater is the required link bitrate needed to transmit a given program. For example, action footage requires greater link bitrate than a talk show where a considerable part of the image is made up of a static background. The applications, and their data—in turn—do not need to be broadcast in real time and thus do not require high bitrate.

### SUMMARY OF THE INVENTION

1. Purposes of the Invention

It is an object of this invention to provide a method and a device that allow mixing signals of different types and varying priority.

This and other objects and advantages of the present invention will become evident from the description which follows.

2. Brief Description of the Invention

The object of the present invention is a device for multiplexing of data having a multiplexer with different types of inputs. These are: live signal inputs for signals transmitted live, bitrate inputs—for which appropriate bitrate needs to be maintained, as well as weight inputs—with priorities defined by the weight coefficient. The weight coefficient is a number from 0 to n, defining the rate at which data is read from each input of this type. Multiplexer inputs are buffered, providing the basic signal. The multiplexer merges the input signals into a single stream fed at the output. This multiplexer output is connected to one of the inputs of the next multiplexer, this one having at least three inputs. The inputs are arranged in such a way that the live signal inputs have the highest priority, the bitrate inputs transmitting television signals have a medium priority, and the weight inputs have the lowest priority.

The live signal inputs—with the highest priority—are characterized by the fact that data appearing at the input is immediately sent to the output. If there are more live signal inputs than only data from the highest priority inputs is guaranteed to be sent without any delays.

Medium priority bitrate inputs are characterized by the bitrate with which the data is read from a specific input.

The low priority weight inputs are characterized by the rate at which data is read from the various inputs, with the data read rate being defined by an integer number showing how many times more often the data will be read from a given input, as compared with an input of the lowest priority, equaling 1. For example, data from a weight=3 input will be read three times more often than data from a weight=1 input. Data from these inputs is the last in line to be read, if there is no data accessible at the live signal or at the bitrate inputs.

All data is transmitted in packets, the structure of which is defined by the user. Each packet comprises a header and data. The header should contain information as to the source of the packet. This is to enable demultiplexing of the output sequence. Dataflow inside the system is based on requests for packets made superior system elements.

A packet appearing at one of the circuit inputs is sent to its output. In case there is no packet at a given input, information about the lack of a packet is sent instead. The reading of a packet from an input and sending it to an output is activated by a packet request command, sent to a module connected to the given input. The requested packet, or information of its lack, is then awaited. Subsequently, a search for packets is conducted at live signal inputs, beginning with the input defined as the first in line. If no packet is found at the highest priority input, the search moves on to subsequent live signal inputs. If no packets are available at these inputs, bitrate inputs are checked, beginning with the one having the highest coefficient of sending, bypassing inputs with a coefficient of sending greater or equal to one. The coefficient of sending is calculated for each of these inputs. It defines the relationship of the amount of data received from a given input to that input's data transmission speed, multiplied by the time elapsed since the amount of data received was last reset. This coefficient is reset following a preset period of time. In case when no packets are found at the bitrate inputs, the search proceeds to check the weight inputs. The coefficient of sending is calculated for each of them. This coefficient defines the relationship of the amount of data received from a given input to the weight coefficient assigned to that input. The search for data at the weight inputs is conducted in the order defined by the coefficient of sending for the individual inputs, beginning with the input with the highest coefficient of sending. The coefficient of sending is reset following a preset period of time.

The novel features which are considered as characteristic for the invention are set forth in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

In the accompanying drawings, there is shown one of the various possible embodiments of the present invention:

FIG. 1 is a simplified diagram of a multiplexing circuit;

FIG. 2 is a flow diagram of a general algorithm for checking buffered inputs;

FIG. 3A, and FIG. 3B show a flow diagram of multiplexer functioning algorithm;

FIG. 4 is a flow diagram of a procedure for checking live signal inputs;

FIG. 5 is a flow diagram of a procedure for checking bitrate inputs;

FIG. 6 is a flow diagram of a reset procedure; and

FIG. 7 is a flow diagram of a procedure for checking weight inputs.

### DESCRIPTION OF INVENTION AND PREFERRED EMBODIMENT

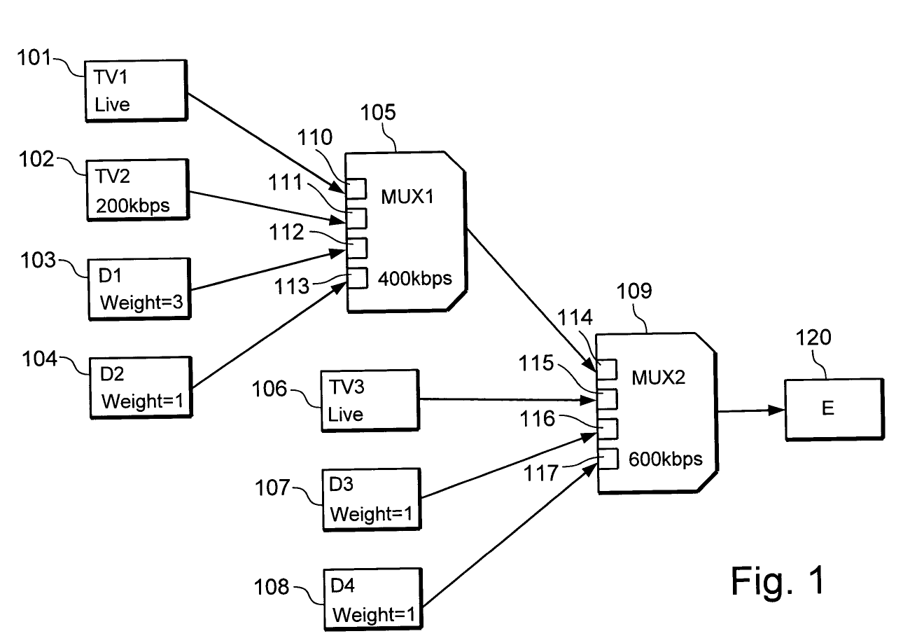

As shown in FIG. 1, an exemplary data multiplexing circuit comprises two multiplexers: MUX1 105, and MUX2 109. An output of the MUX1 first multiplexer 105 is connected directly to one of inputs of the MUX2 second multiplexer 109. The MUX1 first multiplexer 105 has a TV1 live television signal input 101, shortly a TV1 input, a TV2 television signal input 102, shortly a TV2 input, with the bitrate of 200 kbps, as well as a D1 data input 103 and a D2 data input 104. Weight coefficients of the D1 data input 103, and the D2 data input 104 are set up in such a way that three times as much data can be sent from the D1 data input 103 as from the D2 data input 104. The output of the MUX1 multiplexer 105 has the bitrate of 400 kbps, leaving 100 kbps for the D1 data input 103 and the 104 data input D2. The MUX2 second multiplexer 109 additionally has a TV3 live television signal input, shortly a TV3 input and a D3 data input 107 and a D4 data input 108. The output of the MUX2 multiplexer 109 has the bitrate of 600 kbps, which means that after sending the data from the TV3 input 106, and the data from the MUX1 first multiplexer 105, the remaining band is assigned to the D3 data input 107 and the D4 data input 108. The TV3 input 106 of the MUX2 second multiplexer has the highest priority. Data from this input is sent to the circuit output as soon as it appears. If several of the live transmission type inputs exist, their data is sent as soon as it appears at the input of the MUX2 second multiplexer 109, but the possibility to send data without any delays is available only for the input with the highest priority. The TV1, and TV2 inputs 101, 102 possess medium priority, which describes the bitrate with which the data will be read from a given input. The weight of the D1, D2, D3, and D4 data inputs 103, 104, 107, 108 possess the lowest priority describing the frequency of data being read from a given input. For example, data from a weight=3 input will be read three times more often than data from a weight=1 input. Data from the D1, D2, D3 and D4 data inputs 103, 104, 107, 108 are the last to be read. This means they are read when there is no data found at the TV3 input 106, nor at the bitrate inputs TV1 and TV2 101, 102. The above shows that the circuit is made up of two main types of elements delivering data. They are: the buffered inputs which deliver the basic signal, as well as the MUX1 and MUX2 multiplexers 105, 109, which merge the input signals into a single stream. The functionality of the remaining elements connected to the inputs allows for generating an answer to a packet request, specifying whether a packet is available or not. These are buffered inputs, meaning that the incoming packets are stored in buffers and sent upon receiving a packet request.

All data is transmitted in packets, the structure of which is defined by the user. Each packet comprises a header and data. The header should contain information as to the source of the packet. This is to enable demultiplexing of the output sequence. Dataflow inside the system is based on requests for packets send from E superior system elements 120. The packet appearing at one of the inputs of the first or second multiplexers 105, 109 is sent to its output. In case there is no packet at a given input, information about the lack of a packet is sent instead. The reading of the packet from one of the inputs and sending it to the output is activated by a packet request command, sent to modules 110, 111, 112, 113, 114, 115, 116, 117 connected to the given input. The requested packet, or information of its lack, is then awaited. Subsequently, a search for packets is conducted at the TV1, TV3 live signal inputs 101, 106, beginning with the input defined as the first in line. If no packet is found at the highest priority input, the search moves on to subsequent live signal inputs. If no packets are available at these inputs, the TV2 bitrate input 102 is checked, beginning with the one having the highest coefficient of sending, bypassing inputs with a coefficient of sending greater or equal to one. The coefficient of sending is calculated for each of these inputs. It defines the relationship of the amount of data received from a given input to that input's data transmission speed, multiplied by the time elapsed since the amount of data received was last reset. This coefficient is reset following a preset period of time. In case when no packets are found at the bitrate inputs, the search proceeds to check the weight inputs, for example the 103, 104, 107, 108 data inputs. The coefficient of sending is calculated for each of them. This coefficient defines the relationship of the amount of data received from a given input to the weight coefficient assigned to that input. The search for data at the weight inputs is conducted in the order defined by the coefficient of sending for the individual inputs, beginning with the input with the highest coefficient of sending. The coefficient of sending is reset following a preset period of time.

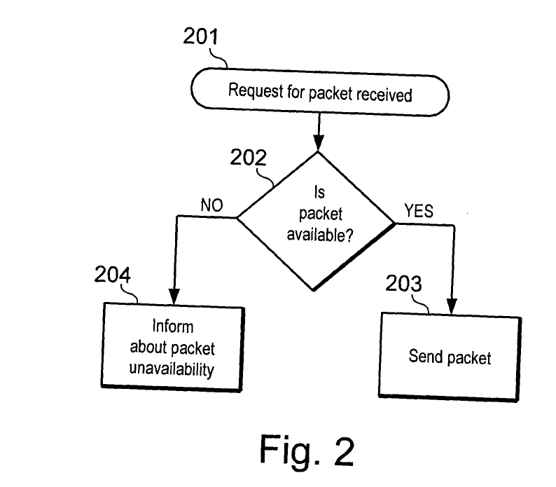

FIG. 2 shows an algorithm illustrating the functioning of buffered inputs. Upon receiving a packet request in step 201, it is checked whether there is a packet available, in step 202. If a packet is available, it is sent in step 203. In the case there are no packets available, information about packets being unavailable is sent in step 204.

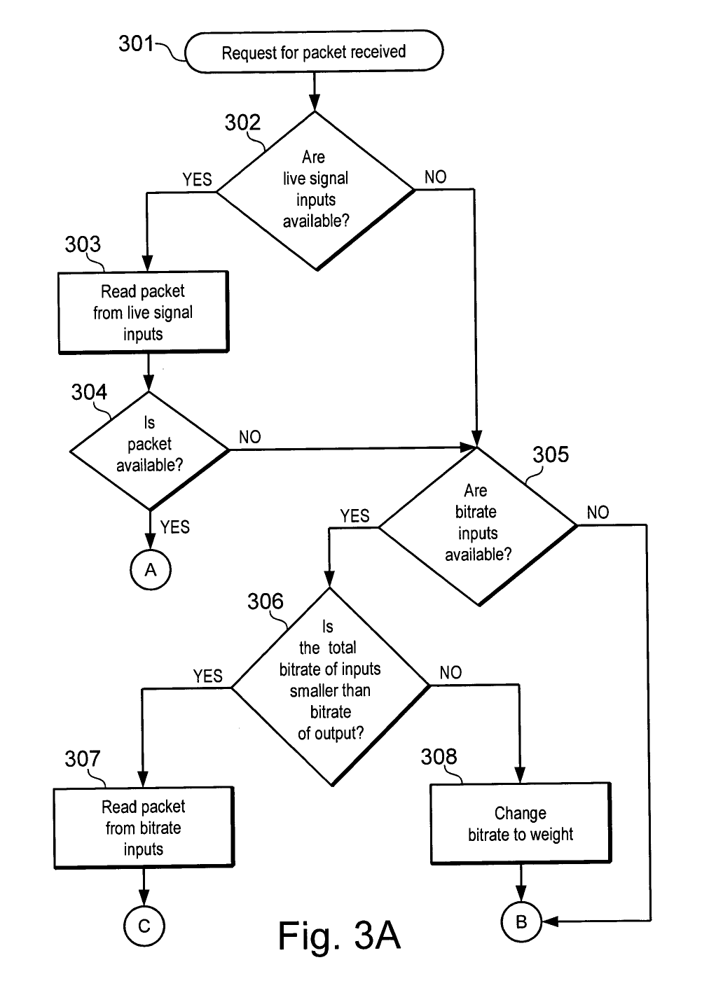

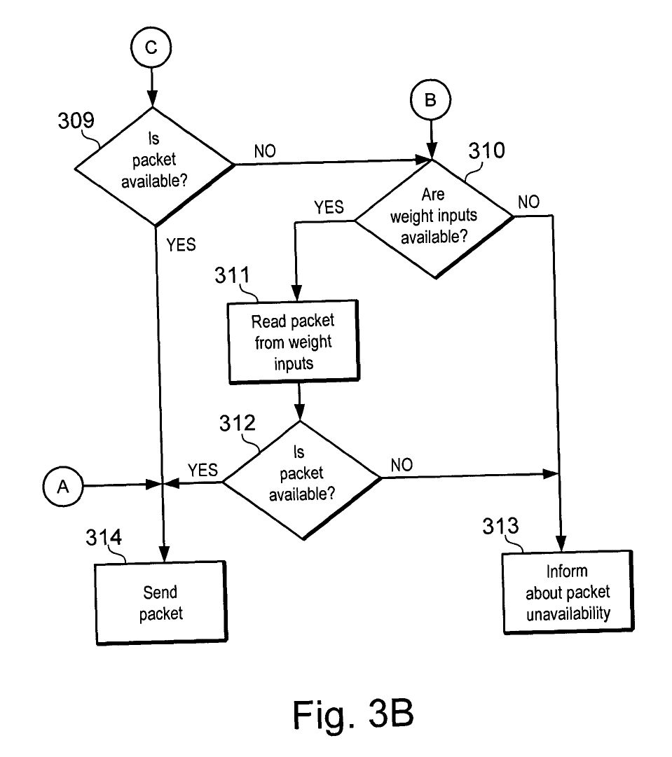

FIG. 3A and FIG. 3B show a flow diagram illustrating the functioning of a multiplexer. The diagram has been divided at points labeled “A”, “B”, and “C”. When a request for a packet is received in step 301, it is checked—in step 302—if there are any live signal inputs connected to the multiplexer. These are inputs with the highest priority, therefore if any of them is found to be available, the search for available packets begins from them. In step 303, the procedure of reading packets from the live signal inputs is initiated. Step 304 contains a check if there is a packet available. If a packet indeed is available, it is sent in step 314. If a packet is not available, a check for packets at bitrate inputs, as well as a check if such inputs themselves are available, is conducted in step 305. In the case bitrate inputs are found available, step 306 contains a check to establish if the sum of their bitrates is smaller than the bitrate of the multiplexer output. If it is, a procedure of checking for packets at bitrate inputs is initiated in step 307. Next, if in step 309 it is determined that a packet is available, it is sent in step 314. In the case the joint bitrate of the inputs is greater than the bitrate of the output, the bitrate of these inputs is converted, in step 308, to a weight coefficient 308. The procedure of searching for packets at the weight inputs, to be initiated later, will include weight inputs as well as bitrate inputs. Due to the fact that a typical input weight is usually described using small numbers (for example 1, 2, 5 . . . ), and bitrate—using large ones (for example 100,000 bps), bitrate inputs will have greater priority and packets will be read from them first. Afterwards, in step 309, the procedure checks if a packet is available. If no packets are available, the search for packets moves on to weight inputs. The procedure also checks, in step 310, if such inputs are available. If they are found to be available, the procedure for searching for packets at these inputs is initiated in step 311. If a packet is found to be available, in step 312, it is sent out in step 314. If no packets are available at any of the inputs, information about packet unavailability is sent out in step 313.

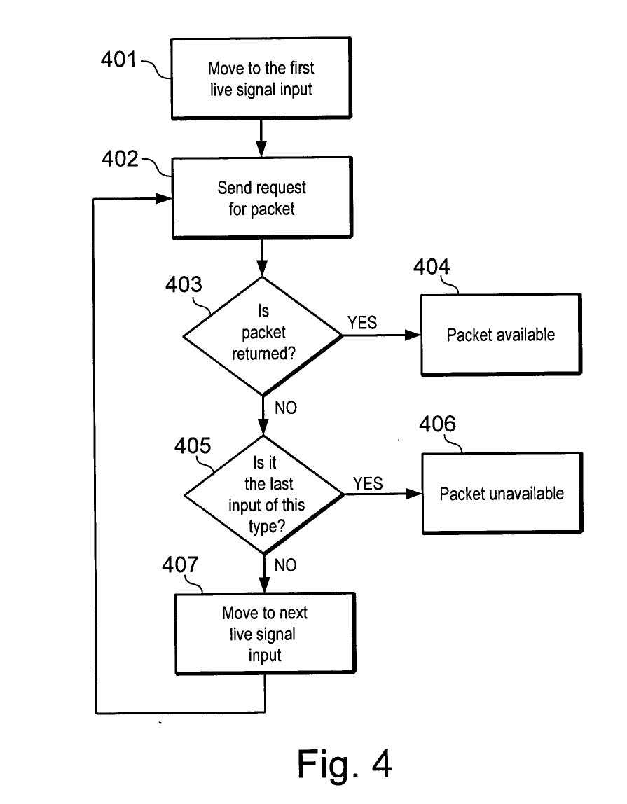

FIG. 4 illustrates a procedure for checking if a packet is available at live signal inputs. In step 401, the procedure initiates the search, starting with the first live signal input, and sends out a packet request in step 402. Next, in step 403, it checks if a packet was returned, or if there is active information about the lack of a packet. If a packet is available at the input being checked, information about locating the packet is sent out in step 404. If information about packet unavailability is fed, the procedure goes on to check, in step 405, if there are any other live signal inputs available. If there are, it moves on to check for packets at the next input, sending out a request in step 407. If not, information about packet unavailability is sent out in step 406.

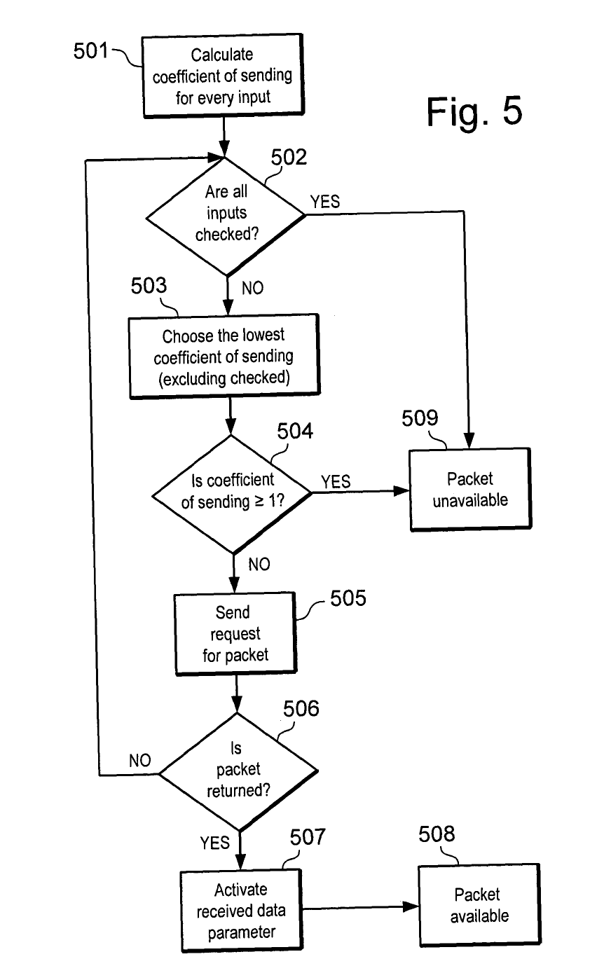

FIG. 5 shows the procedure for checking for packets at bitrate inputs. In order to ensure the required bitrate, the coefficient of sending is used, labeled cs, and calculated according to the following formula:

cs=(data received)/(bitrate×time)

where:

data received—a variable describing the amount of data received from the beginning of time interval T.

bitrate—transmission speed of data coming out of a given input.

time—time elapsed since the beginning of the time interval T.

The time interval T is the period of time during which data received at every input is monitored. The procedure of resetting the value of data received at a given input is initiated at T intervals.

The procedure shown in FIG. 5 begins in step 501 with the calculation of the coefficient of sending for each input. In step 502, it goes on to check if all inputs have been checked for availability of packets. If not, then in step 503 the procedure picks the input with the lowest coefficient of sending, bypassing the inputs already checked for packets at the time of initiating the procedure. It then goes on to check, in step 504, if the coefficient of sending of the read input is greater or equal to one. If it is, this means that data from the remaining inputs was received at the appropriate bitrate, and that there are no further packets to be sent. If it is not, the procedure sends out a packet request to the given input in step 505. It then checks, in step 506, if a packet has been returned. If it was, then in step 507 the data received parameter for the given input is increased by the size of the received packet. Information about finding the packet is next sent out in step 508. In the case the cs coefficient is greater or equal to 1, information about the packet being unavailable is sent out in step 509.

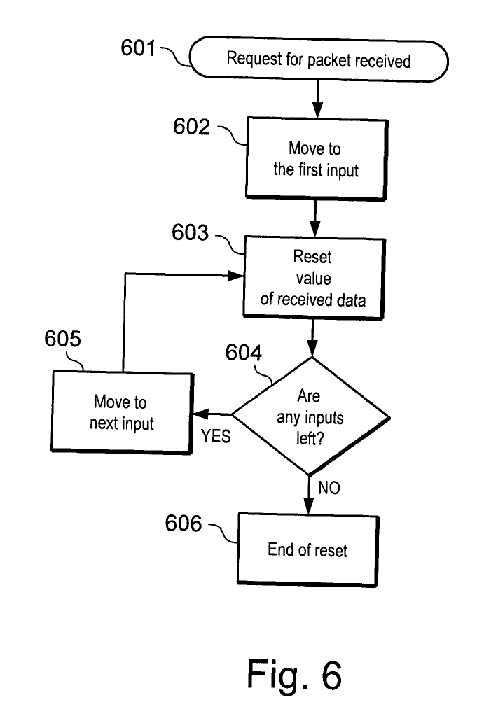

An algorithm of the resetting procedure is presented in FIG. 6. The procedure is initiated after time interval T has elapsed since the last reset, after receiving a packet request in step 601 and moving to the first input in step 602. The value of data received at that input is reset in step 603. A check is made next, in step 604, to find out if there are any other inputs of this type. If there are, the procedure in step 605 moves on to the next input. If not, information as to the reset being complete is sent out in step 606.

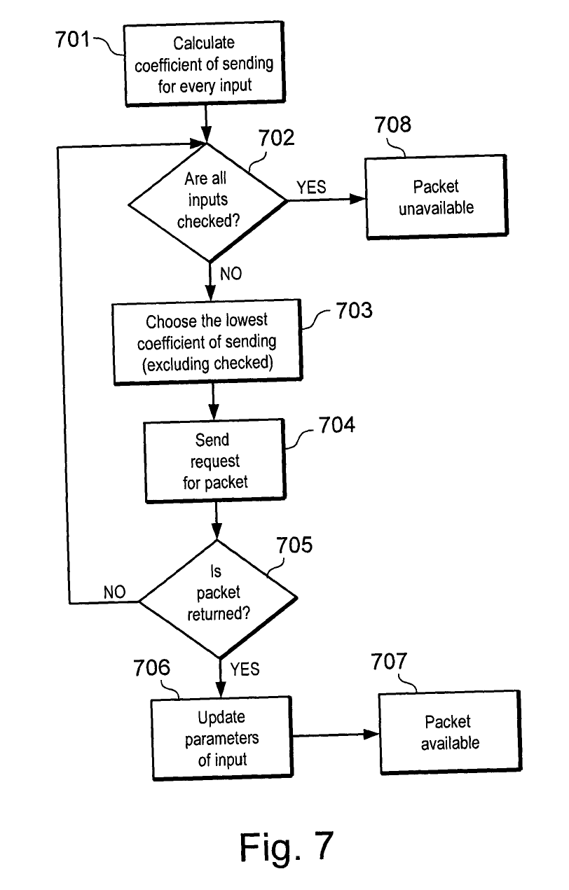

FIG. 7 shows the procedure for checking if there is a packet available at the weight inputs. It is similar to the procedure shown in FIG. 5. However, the difference is that the coefficient of sending for the weight inputs may exceed one. That is why in calculating the coefficient of sending here, time is not taken into consideration. These inputs also have no specified bitrate. Any data appearing here may be sent when requested by the multiplexer. The coefficient of sending (cs) for the weight inputs is defined according to the following formula:

cs=data received/weight

where:

data received—a variable defining the amount of data received since the beginning of time period T.

weight—the weight coefficient defined for the given input.

Time interval T may be equal to the time interval T for bitrate inputs. The resetting formula for the value of data received from the bitrate inputs will also reset the value of data received from the weight inputs. If the time intervals T are different, two separate procedures are initiated.

The procedure begins in step 701 by calculating the coefficient of sending for each of the inputs. It next checks, in step 702, if all of the inputs have been checked for packets. If not, then in step 703 the procedure picks the input with the lowest coefficient of sending, bypassing the inputs already checked for packets at the time of initiating the procedure. It then sends to the given input a request for a packet in step 704. In step 705, it goes on to check if a packet has been returned. If it finds that to be the case, then in step 706 the data received parameter for the given input is increased by the size of the received packet. Information about finding the packet is then sent out in step 707. If all the inputs are checked and no packets are found at any of them, information that no packets are available is sent out in step 708.

The method and multiplexers described above may be used, for example, to transmit digital television data in the MPEG format, where the data is generated by several sources. These sources could be: a television signal source, an application source, or a data source. Another advantage of the presented data multiplexing method is the extension of existing multiplexing algorithms, allowing to limit the number of multiplexers that are needed, through appropriate operations conducted on the data, merging the functionality of multiple units into a single one.

It will be understood that each of the elements described above, or two or more together, may also find a useful application in other types of devices for multiplexing differing from the types described above.

While the invention has been illustrated and described as embodied in the context of a device for multiplexing of data, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

We claim:

1. A device for multiplexing of data comprising
a first multiplexer having
first live signal inputs for signals transmitted live and/or
first bitrate inputs for which appropriate bitrate needs to be maintained and/or
first weight inputs with priorities defined by a weight coefficient,
a first output and
modules connected to said first inputs for receiving packet request commands which request reading of packets at said inputs and sending the packets to the first output wherein the multiplexer merges signals from said first inputs into a first single stream fed at the first output and wherein the said first inputs are buffered.

2. The device for multiplexing according to claim 1 wherein the weight coefficient is a number from 0 to n defining a rate at which data is read from each input of the first weight inputs and showing how many times more often will the data be read from a given first weight input, as compared with a first weight input of the lowest priority, equaling 1.

3. The device for multiplexing according to claim 1 wherein the first live signal inputs have the highest priority, the bitrate inputs transmitting television signals have medium priority, and the weight inputs have the lowest priority.

4. The device for multiplexing according to claim 1 wherein data appearing at the first live signal inputs as packets is immediately sent to the first output and wherein only data from the highest priority input is guaranteed to be sent without any delays.

5. The device for multiplexing according to claim 1 wherein data appearing at the first bitrate inputs is read with a specific bitrate defined by a number larger than 0.

6. The device for multiplexing according to claim 1 further comprising
a second multiplexer having
second live signal inputs for signals transmitted live and/or second bitrate inputs for which appropriate bitrate needs to be maintained and/or second weight inputs with priorities defined by the weight coefficient, where one of said second multiplexer inputs is linked to the first output of the first multiplekser,
a second output and
modules connected to said second multiplexer inputs for receiving packet request commands which request reading of packets at said second inputs and sending the packets to the second output wherein the second multiplexer merges the signals from said second inputs into a second single stream fed at the second output and wherein said second inputs are buffered.

7. A method for multiplexing of data in a system for dataflow management
using multiplexers comprising
receiving by a multiplekser a request for a packet;
checking if any live signal inputs are connected to the multiplexer;
initiating a procedure of reading packets from the live signal inputs and checking if a packet is available;
reading and sending a found packet to an output when the packet was available until all live signal inputs are checked and packets are sent;
checking if any bitrate inputs are connected to the multiplexer;
checking if a sum of bitrates of the bitrate inputs is smaller than a bitrate of a multiplexer output;
initiating a procedure of checking for packets using bitrate when the bitrate inputs are found available and the sum of the bitrates of the bitrate inputs is smaller than the bitrate of the multiplexer output and sending found packets until all packets are sent;
treating the bitrates of the bitrates inputs as weight coefficients when the sum of the bitrates of the bitrates inputs is greater than the bitrate of the output and treating the bitrates inputs as weight inputs;
initiating a procedure of searching for packets at the weight inputs when the weight inputs are found available and sending found packets until all packets are sent;
sending information about packet unavailability when no packets are available; and
waiting for the request for a packet.
